(19) United States
(12) Patent Application Publication
(10) Pub. No.: US 2005/0031213 A1
(43) Pub. Date: Feb. 10, 2005

(54) Acquisition method and apparatus for generating m-degree forms in a n-dimension space

(76) Inventor: Jean-Francois Rotge, Montreal (CA)

Correspondence Address: OGILVY RENAULT, 1981 MCGILL COLLEGE AVENUE, SUITE 1600, MONTREAL, QC, H3A2Y3, CA

(21) Appl. No.: 10/896,332

(22) Filed: Jul. 22, 2004

Related U.S. Application Data
(60) Provisional application No. 60/488,770, filed on Jul. 22, 2003.

(51) Int. Cl. G06K 9/36

(52) U.S. Cl. 382/232

(57) ABSTRACT

A method and apparatus are disclosed for generating an m-degree algebraic equation representative of an object, in a n-dimension space using a received image data stream representative of the object and further wherein a plurality of control points are associated on the received image data stream according to a desired m-degree form and further wherein the algebraic equation is generated using at least the associated plurality of control points.

### RELATED APPLICATION

This patent application claims priority of US provisional patent application N°60/488,770, entitled “Acquisition Method and Apparatus for Providing M-degree forms in a N-dimension space”, that was filed Jul. 22, 2003, the specification of which is hereby incorporated by reference. This patent application is further related to co-pending US patent application N°10/319,836 entitled “Method and apparatus for generating M-degree forms in a N-dimension space” and that was filed Dec. 16, 2002 which claims priority of US provisional patent application N°60/339,406 that was filed Dec. 14, 2001, the specifications of which are incorporated by reference.

### FIELD OF THE INVENTION

The invention relates to the field of computer graphics. More precisely, this invention pertains to the field of generating an m-degree algebraic equation representative of a form.

### BACKGROUND OF THE ART

It is very desirable to provide an apparatus which generates a representation, for various applications, of an object or a plurality of objects.

Unfortunately, such apparatus has usually many limitations. For instance, it is built and dedicated for specific applications.

Furthermore, such apparatus usually requires a lot of computing resources for processing an acquired data which leads to expensive devices.

Moreover, such apparatus usually provides a representation which is an estimation of the object at a certain scale. Zooming-in or zooming-out is usually only possible using interpolation techniques which may lead to noticeable artifacts.

There is a need for a method and apparatus that will overcome at least one of the above-identified drawbacks.

Features of the invention will be apparent from review of the disclosure, drawings and description of the invention below.

### SUMMARY OF THE INVENTION

A first advantage of the invention is that it enables the provision of a m-degree algebraic equation representative of an object using an image data stream representative of the object.

A further advantage is the fact that the provision of the m-degree algebraic equation may be automatic or non-automatic.

The invention provides a method for generating an m-degree algebraic equation representative of an object, in a n-dimension space, the method comprising receiving an image data stream representative of the object, associating a plurality of control points on the received image data stream according to a desired m-degree form and generating said algebraic equation representative of the object using at least the associated plurality of control points.

According to another aspect of the invention, there is provided an apparatus for generating a m-degree algebraic equation representative of an object, in a n-dimension space, the apparatus comprising an image acquisition data providing unit providing an image data stream representative of the object, a data analyzing unit receiving the provided image data stream and providing an analyzed image data stream signal, a processing unit receiving the analyzed image data stream signal, associating a plurality of control points on the analyzed image data stream signal according to a desired m-degree form to generate an algebraic equation signal and an algebraic equation providing unit receiving and providing the algebraic equation signal.

According to another aspect of the invention, there is provided an acquisition module for generating a m-degree form in a n-dimension space representative of an object, the acquisition module comprising a memory comprising an indication of at least one acquisition to perform, the indication being related to a geometric condition required for generating the m-degree form representative of the object, a processing unit receiving the indication of the acquisition to perform and providing a request for performing an acquisition and a data acquisition unit for performing the acquisition of the object and providing an acquired signal in response to the request for performing the acquisition.

The invention further provides a method for acquiring data used to generate a m-degree form, representative of an object, in a n-dimension space, the method comprising selecting an indication of at least one acquisition to perform in a database comprising the indication of at least one acquisition to perform, the indication being related to a geometric condition required for generating the m-degree form representative of the objects, performing the acquisition using the selected indication of at least one acquisition to perform to provide an acquired signal and processing the acquired signal to provide a processed acquired signal.

### DESCRIPTION OF THE DRAWINGS

In order that the invention may be readily understood, embodiments of the invention are illustrated by way of example in the accompanying drawings.

FIG. 1 is block diagram showing an embodiment of an algebraic equation generating unit comprising an image acquisition data providing unit, a data analyzing unit, a processing unit, a user interface, a segmented data storing unit, a control point storing unit and an algebraic equation providing unit;

FIG. 2 is a flowchart showing how the algebraic equation generating unit operates according to an embodiment;

FIG. 3a is a picture showing a view provided by a Computed-Tomography (CT) scan of a thorax;

FIG. 3b is a picture showing a screenshot of a user interface displayed to a user according to an embodiment;

FIG. 4 is a picture showing a screenshot of a user interface displayed to a user according to an embodiment;

FIG. 5a is a picture showing a view provided by a Computed-Tomography (CT) scan of Duramater, Arachnoid and Pia Mater;

FIG. 5b is a picture showing a screenshot of a user interface displayed to a user according to an embodiment;

FIG. 6 is a flowchart showing how control points are positioned using an analyzed image data stream according to an embodiment;

FIG. 7 is a flowchart showing how the algebraic equation is generated using the positioned control points according to an embodiment;

FIG. 8 is a block diagram showing an embodiment of a form acquisition apparatus according to another embodiment;

FIG. 9 is a flowchart showing how the form acquisition apparatus operates according to an embodiment;

FIG. 10 is a flowchart showing how a required condition is detected in one embodiment of the invention; and

FIG. 11 is a flowchart showing how acquired data is processed according to an embodiment.

Further details of the invention and its advantages will be apparent from the detailed description included below.

### DETAILED DESCRIPTION OF PREFERRED EMBODIMENTS

In the following description of the embodiments, reference to the accompanying drawings are by way of illustration of an example by which the invention may be practiced. It will be understood that other embodiments may be made without departing from the scope of the invention disclosed.

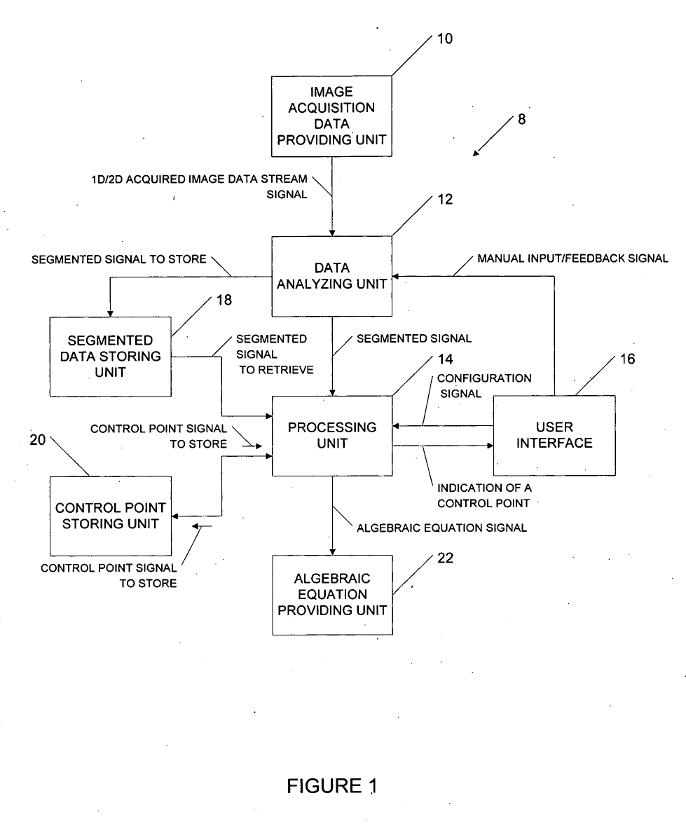

Now referring to FIG. 1, there is shown an embodiment of an algebraic equation generating unit 8.

The algebraic equation generating unit 8 comprises an image acquisition data providing unit 10, a data analyzing unit 12, a processing unit 14, a user interface 16, a segmented data storing unit 18, a control point storing unit 20 and an algebraic equation providing unit 22.

In the case of a medical-imagery application, the image acquisition data providing unit 10 enables the provision of data originating from an image acquisition data providing unit. The image acquisition data providing unit 10, may therefore comprises at least one of a communication port, such as a serial interface, a parallel interface, a universal serial bus (USB) interface, a FireWire interface (IEEE 1394), a data port (operating or not according to a non-standard/proprietary format) or the like. In such case, the image acquisition data providing unit may be selected from a group consisting of Computed-Tomography (CT) scanners, Fluoroscopy apparatus, Positron Emission Tomography (PET) scanners, Ultra-sound apparatus, Molecular-based imaging system or the like. Alternatively, the image acquisition data providing unit may be a storage unit such as a floppy disk reader, a CD-ROM drive, a DVD-ROM drive, a hard-drive, a flash card drive or the like.

The image acquisition data providing unit 10 is adapted for providing a 1-Dimension (1D)/2-dimension (2D) image data stream signal representative of an object to represent with an algebraic equation.

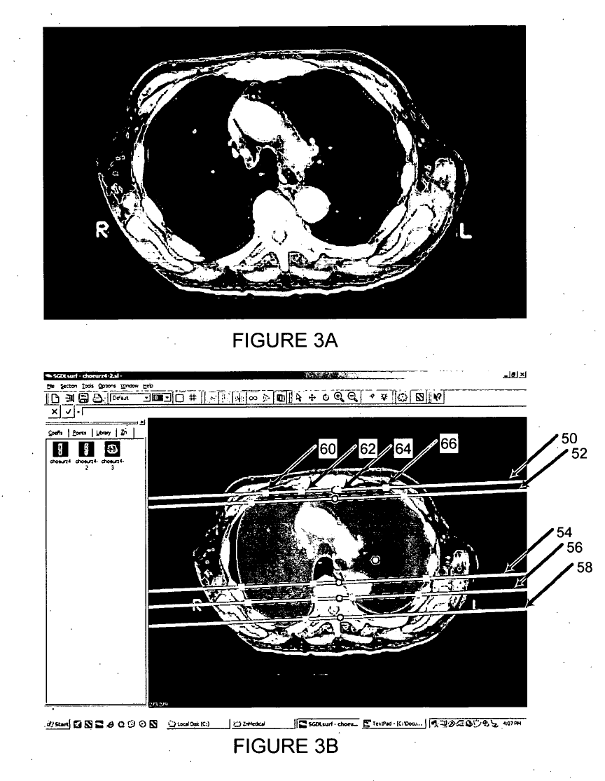

Now referring to FIG. 3a, there is shown an example of an image generated using at least one part of a 2-dimension (2D) image data stream signal. The image generated is representative of a thorax. The 2-dimension (2D) image data stream signal is provided by a Computed-Tomographic (CT) scanner and comprises a plurality of images. It will be appreciated that alternatively, a 1-dimension (1D) image data stream signal may be provided. The skilled addressee will appreciate that the 1-dimension (1D) image data stream signal may be provided faster than the 2-dimension (2D) image data stream signal.

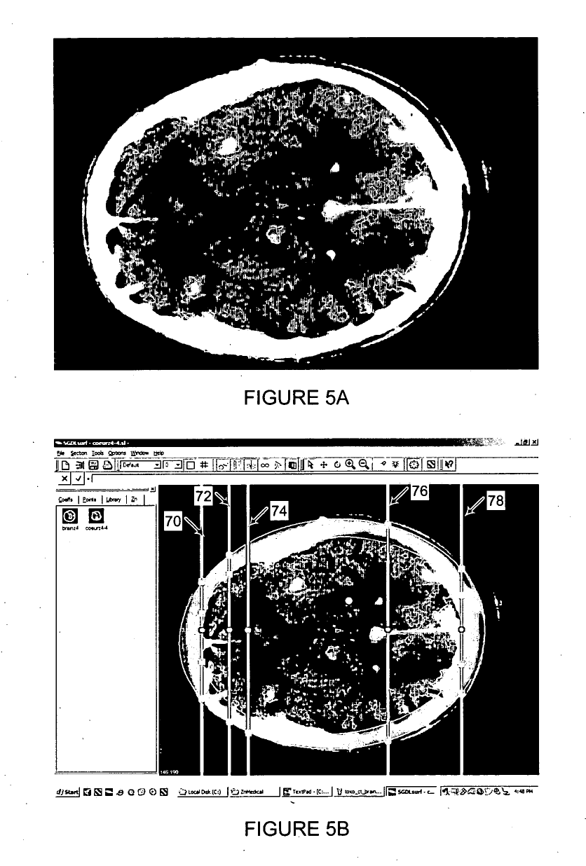

Now referring to FIG. 5a, there is shown another example of an image generated using at least one part of a 2-dimension (2D) image data stream signal. The image is representative of Duramater, Arachnoid and Pia Mater.

Now referring back to FIG. 1, the data analyzing unit 12 receives the 1D/2D acquired image data stream signal provided by the image acquisition data providing unit 10 and performs a data analysis to provide a segmented data signal.

The segmented data signal is provided to the processing unit 14. At least one part of the segmented data signal, also referred to as a segmented signal to store, is stored by the data analyzing unit 12 in the segmented data storing unit 18.

The data analyzing unit 12 may receive a manual input/feedback signal provided by the user interface 16 as explained below.

In fact, it should be understood that the data analyzing unit 12 performs a segmentation of the 1D/2D acquired image data stream signal provided by the image acquisition data providing unit 10. The data analyzing unit 12 performs the segmentation according to at least one segmentation algorithm. The skilled addressee will be able to select a suitable segmentation algorithm depending on the desired application. The skilled addressee will appreciate that the segmentation algorithm is selected according to various parameters such as the type of 1D/2D acquired image data stream signal, an intended application for the generated algebraic equation, etc. Alternatively, the data analyzing unit 12 may comprise more than one segmentation algorithm operating in parallel and a selection may be performed on more than one corresponding result.

It should be understood that the purpose of the segmentation is to locate, on the 1D/2D acquired image data stream signal, a plurality of points indicative of the surface of the object to represent with the algebraic equation. Using the plurality of points indicative of the surface of the object, it is then possible to adequately position a plurality of control points. As mentioned in the above-identified co-pending patent application, a control point may be one of a polar point and a non-polar point. It is also disclosed in the co-pending patent application that a polar point and its related non-polar point meet at a surface point. Localizing the plurality of points indicative of the surface is therefore of great interest for positioning the control points and therefore generating the algebraic equation of the surface.

The user interface 16 receives an indication of a control point signal and provides a configuration signal to the processing unit 14. The user interface 16 further provides a manual input/feedback signal to the data analyzing unit 12.

The user interface 16 is provided to an operator via a display device such as a Cathode Ray Tube (CRT), a LCD display or the like.

Now referring to FIG. 3B, there is shown an example of a user interface 16 displayed to a user.

In one embodiment, the user interface 16 displayed to a user comprises a view indicative of at least one part of the 1-Dimension (1D)/2-dimension (2D) image data stream signal together with a plurality of lines and a plurality of control points located thereon. Still in this embodiment, a single view is displayed for each section. For instance, the user interface 16 displayed comprises a section having a first line 50, a second line 52, a third line 54, a fourth line 56 and a fifth line 58.

In fact, the skilled addressee will appreciate that depending on the degree of the algebraic equation and further depending on the dimension space, a given number of sections, each section comprising a given number of lines, each line comprising a given number of control points, have to be provided as explained in the above-identified patent application in order to determine the corresponding algebraic equation. The skilled addressee should therefore appreciate that the 1-Dimension (1D)/2-dimension (2D) image data stream signal must therefore comprise data for defining another given number of sections. In an embodiment, the operator is able to toggle between various views, each single view being representative of a given section.

Still referring to FIG. 3b, the first line 50 comprises a first polar point superimposed with its related non-polar point 60, a second polar point superimposed with its related non-polar point 62, a third polar point superimposed with its related non-polar point 64 and a fourth polar point superimposed with its related non-polar point 66.

The second line 52 comprises four polar points, the third line 54 comprises six polar points.

The fourth line 56 comprises eight polar points.

The fifth line 58 comprises two polar points.

The skilled addressee will therefore appreciate that FIG. 3b discloses therefore a view indicative of a first section of a quartic. The skilled addressee will further appreciate that in this embodiment, an indication of the form generated according to the generated algebraic equation may be provided in the displayed view and therefore enables the operator to have an indication of the form generated.

It should be further appreciated that the user interface 16 displayed to the operator and illustrated by FIG. 3 may enable the operator to move at least one control point of the plurality of control points provided on the view. Moving at least one control point enables the user to perform a fine tuning of the form generated in a “trial and error” fashion. The manual input/feedback signal is then provided in such embodiment by the user interface 16 to the data analyzing unit 12.

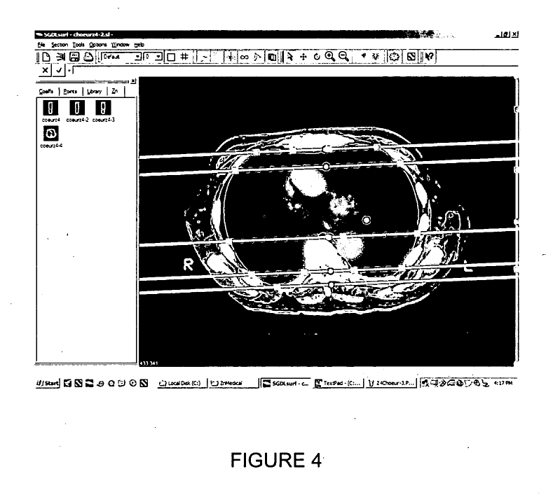

Now referring to FIG. 4, there is shown another example of the user interface 16 displayed to the operator.

Now referring to FIG. 5b, there is shown an example of a user interface generated using at least one part of the 1-Dimension (1D)/2-dimension (2D) image data stream signal of an object, a view of which is displayed in FIG. 5a.

In this embodiment, the user interface displayed to the user comprises a first line 70, a second line 72, a third line 74, a fourth line 76 and a fifth line 78. Each line comprises a given number of control points according to a degree of an algebraic equation to generate and further according to a dimension space degree.

Now referring back to FIG. 1, an optional segmented data storing unit 18 receives a segmented signal to store provided by the data analyzing unit 12 and stores it. The skilled addressee will appreciate that it may be interesting to store data in the case where at least one part of the segmented data is to be reused in the future or amended for instance.

The processing unit 14 receives the segmented data and a configuration signal provided by the user interface 16 and generates an algebraic equation signal indicative of the algebraic equation generated using the control points according to the solving scheme disclosed in the above-identified patent application.

The algebraic equation signal is provided to the algebraic equation providing unit 22. The algebraic equation providing unit 22 is adapted for providing the algebraic equation signal to an external apparatus (not shown). The apparatus may be anyone of a ray-tracing unit, a storing unit, an analyzing unit or any apparatus suitable for using the generated algebraic equation. The skilled addressee will therefore appreciate that the algebraic equation providing unit 22 may therefore depend on the desired application.

The optional control point storing unit 20 receives a control point signal to store which is provided by the processing unit 14 and provides a control point signal to retrieve which is provided back to the processing unit 14.

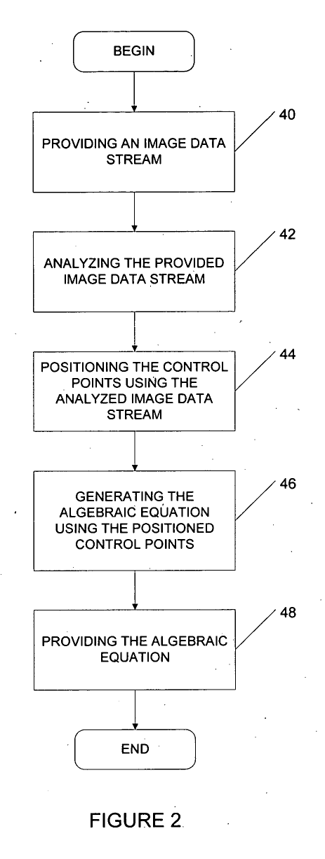

Now referring to FIG. 2, there is shown how the algebraic equation generating unit 8 operates according to an embodiment of the invention.

According to step 40, an image data stream, also referred to as the 1D/2D acquired image data stream signal, is provided by the image acquisition data providing unit 10.

According to step 42, the provided image data stream is analyzed. In one embodiment, the provided image data stream is analyzed by the data analyzing unit 12.

According to step 44, control points are positioned using at least one part of the analyzed image data stream.

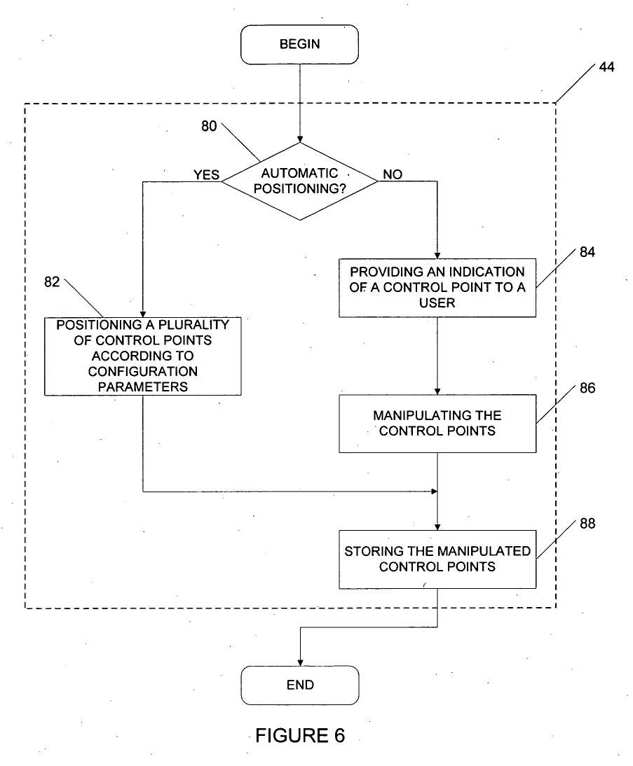

Now referring to FIG. 6, there is shown how the control points are positioned using the analyzed image data stream. According to step 80, a test is performed in order to find out if an automatic positioning should be performed.

It will be appreciated that an automatic positioning does not require a user interaction while a non-automatic positioning requires a user interaction using the user interface 16.

In the case where an automatic positioning should be performed and according to step 82, a plurality of control points are positioned according to configuration parameters stored in a configuration database, not shown in FIG. 1. The configuration parameters comprise for instance the degree of the equation to generate, the degree of the dimension space, etc.

In the case where a non-automatic positioning should be performed and according to step 84, an indication of a control point is provided to a user via the user interface 16.

According to step 86, at least one control point is manipulated by the user via the user interface 16. The skilled addressee will understand that by manipulating the at least one control point in the user interface 16, the user may appreciate in real-time the result from the manipulation of the at least one control point. Furthermore, it will be appreciated that the user may modify the generated form corresponding to the generated algebraic equation.

According to step 88, an optional storing of the manipulated control points may be performed.

Now referring back to FIG. 2 and according to step 46, the algebraic equation is generated using the positioned control points. In one embodiment, the algebraic equation is generated by the processing unit 14.

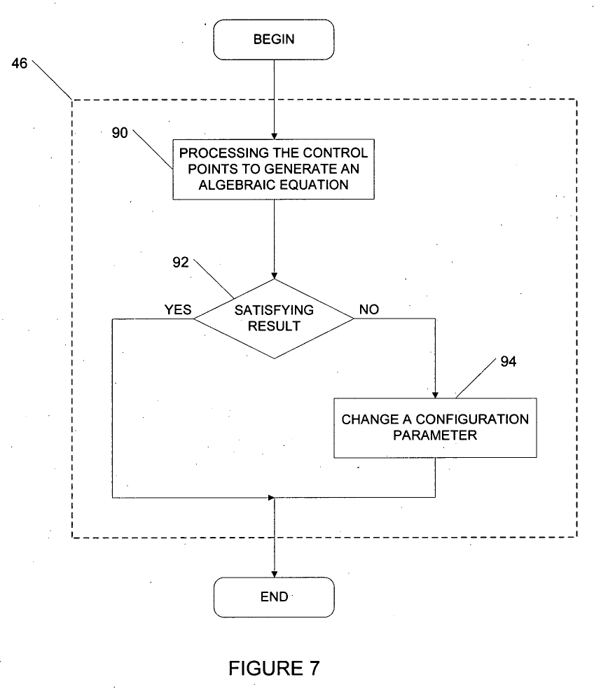

Now referring to FIG. 7, there is shown how the algebraic equation is generated using the positioned control points in one embodiment.

According to step 90, the control points are processed to generate an algebraic equation. The control points are processed using the processing unit 14 and according to the description provided in the US patent application N°10/319,836.

According to step 92, a test is performed in order to find out if the result is satisfying.

In the case where the result is not satisfying and according to step 94, a configuration parameter may be changed by the user via the user interface 16. In such case, the user interface provides a configuration signal to the processing unit 14. The skilled addressee will appreciate that the degree of the algebraic equation may be increased/decreased depending on the result. The skilled addressee will also appreciate that at least one part of the existing control point may be reused in the future.

Now referring back to FIG. 2 and according to step 48, the algebraic equation is provided by the algebraic equation providing unit 22 which provides it to an external apparatus (not shown).

The skilled addressee will appreciate that the algebraic equation generating unit 8 may be used in a broad variety of applications.

For instance, the algebraic equation generating unit 8 may be used in geodesy applications. In such case, the algebraic equation generating unit 8 provides an algebraic equation representative of a topography of a place. Still in this embodiment the 1D/2D acquired image data stream signal may be provided by a satellite imaging system, a radar imaging system or the like.

The algebraic equation generating unit 8 may further be used for modeling industrial parts or components. In such case, the algebraic equation generating unit 8 provides an algebraic equation representative of at least one part of the industrial part or component and may be used in a wide variety of applications such as in a form recognition application, a failure detection application, etc.

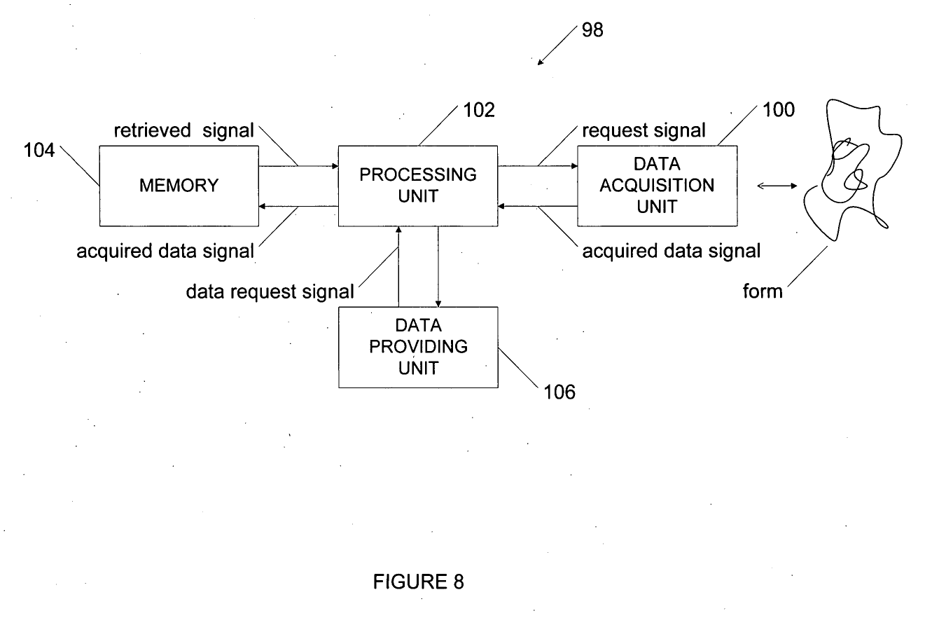

Now referring to FIG. 8, there is shown another embodiment of a form acquisition apparatus 98 comprising a data acquisition unit 100, a processing unit 102, a memory 104 and a data providing unit 106.

The acquisition unit 100 may be any one of a laser acquisition unit, a microwave acquisition unit, etc.

The acquisition unit 100 receives a request signal from the processing unit 102. The request signal comprises a request for a control point.

As explained in the above-identified patent application, a plurality of control points is provided by the form acquisition apparatus to a control point to algebraic coefficient converter 26. The control point to algebraic coefficient converter 26 may then provide algebraic coefficients to any one of an output interface, a ray-tracer, a storing unit, etc.

The data acquisition unit 100 provides an acquired data signal of the object or the like to the processing unit 102. The acquired data signal comprises information with respect to a control point acquired in one embodiment.

The processing unit 102 processes the acquired data signal and stores the processed acquired data signal in the memory 104.

Upon request from the data providing unit 106 to the processing unit 102 using a data request signal, the processing unit 102 retrieves the processed data stored in the memory 104 and provides the retrieved data to the data providing unit 106.

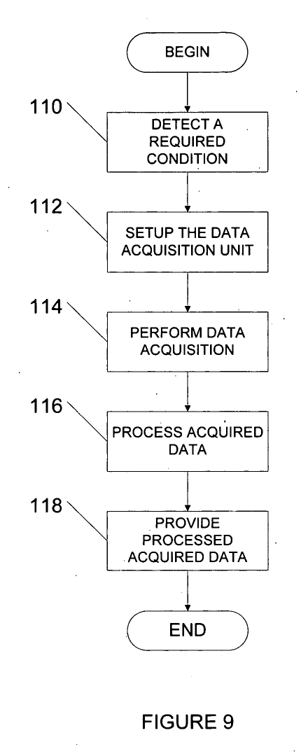

Now referring to FIG. 9, there is shown how the acquisition is performed in an embodiment.

According to step 110, a required geometric condition is detected.

According to step 112, the data acquisition unit 100 is setup according to the required geometric condition.

According to step 114, a data acquisition, according to the required geometric condition, is performed using the data acquisition unit 100 in order to provide the acquired data.

According to step 116, the acquired data is processed by the processing unit 102.

According to step 118, the processed acquired data is provided by the processing unit 102 to the memory 104.

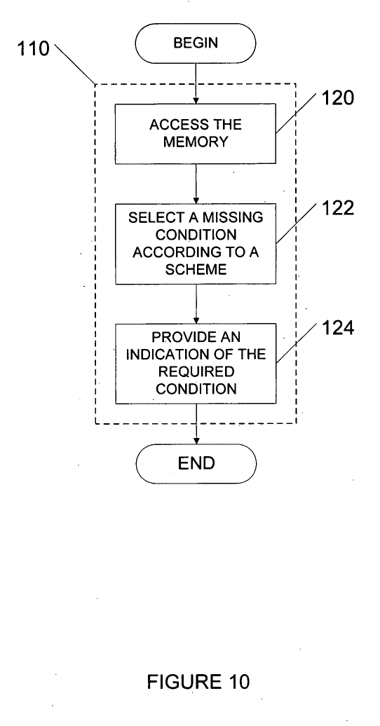

Now referring to FIG. 10, there is shown how the required geometric condition (step 110) is detected in an embodiment.

According to step 120, the memory 104 is accessed by the processing unit 102. The memory 104 is accessed in order to collect an indication of at least one acquisition to perform. As explained in the co-pending US patent application N°10/319,836, incorporated by reference, depending on a geometric form to generate, a predetermined number of points have to be acquired according to a predetermined number of geometric conditions. Furthermore, each point of the predetermined number of points is located on a line of a plurality of lines and each line is located on more than one geometric surfaces. In one embodiment of the invention, a polar point is located at the same position as a non-polar point. In an alternative embodiment, the polar points and the non-polar points are located at different positions.

According to step 122, a missing geometric condition is selected according to a scheme. The missing geometric condition may be related to at least one point located on a single line, to a plurality of points located on more than one line, or to a plurality of points located on a geometric surface.

It has been contemplated that it may be advantageous to perform the at least one acquisition in a specific order. More precisely, the at least one acquisition may be advantageously performed on a line to line basis, on a surface to surface basis, etc.

According to step 124, an indication of the required geometric condition is provided. A required geometric condition is defined as a missing geometric condition which must be provided in order to complete the acquisition process. In one embodiment, the required geometric condition is selected according to a specific selection scheme, while in another embodiment, the required geometric condition is not selected according to a specific selection scheme.

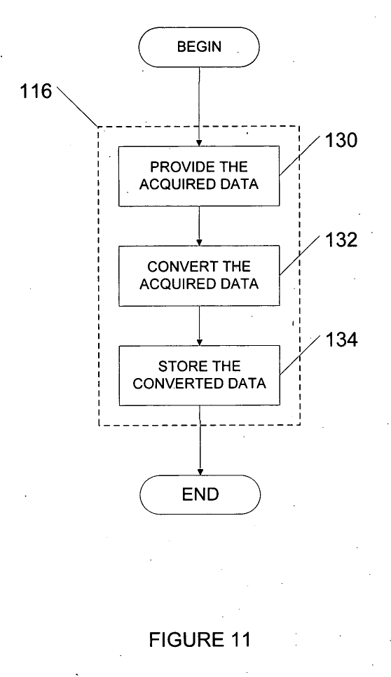

Now referring to FIG. 11, there is shown how acquired data is processed.

According to step 130, the acquired data is provided by the data acquisition unit 100 to the processing unit 102.

According to step 132, the acquired data is converted by the processing unit 102 according to a conversion scheme. In fact, it will be appreciated that data are collected differently depending on the data selected acquisition unit 100. It may be therefore necessary to adapt the data collected in order to make them suitable for generating the form representative of the object or the like.

According to step 134, the converted data is stored in the memory 104 by the processing unit 102.

Although the above description relates to a specific embodiment as presently contemplated by the inventor, it will be understood that the invention in its broad aspect includes mechanical and functional equivalents of the elements described herein.

1. A method for generating an m-degree algebraic equation representative of an object, in a n-dimension space, said method comprising:
receiving an image data stream representative of said object;
associating a plurality of control points on the received image data stream according to a desired m-degree form;
generating said algebraic equation representative of said object using at least the associated plurality of control points.

2. The method as claimed in claim 1, wherein said associating of said plurality of control points on the received image data stream comprises performing an analysis of the image data stream to provide an analyzed data and further wherein said associating of said plurality of control points is performed using the analyzed data and according to the desired m-degree form.

3. The method as claimed in claim 2, wherein said analysis comprises performing a segmentation of the image data stream to locate a surface of said object in said image data stream.

4. The method as claimed in claim 3, further comprising displaying on a user interface said generated algebraic equation.

5. The method as claimed in claim 4, wherein said displaying is performed superimposed to said image data stream representative of said object.

6. The method as claimed in claim 3, wherein said segmentation is performed according to a plurality of algorithms providing a plurality of corresponding results and further wherein at least one result is selected.

7. The method as claimed in claim 1, wherein said associating of said plurality of control points on the received image data stream is performed by a user.

8. The method as claimed in claim 7, further comprising displaying on a user interface said generated algebraic equation.

9. The method as claimed in claim 8, further performing a test to find out if said generated algebraic equation is satisfying.

10. The method as claimed in claim 9, wherein said generated algebraic equation is not satisfying and further performing one of increasing said m-degree and decreasing said m-degree.

11. The method as claimed in claim 8, wherein said displaying is performed superimposed to said image data stream representative of said object.

10. The method as claimed in claim 1, further comprising storing said plurality of associated control points.

11. The method as claimed in claim 1, wherein said image data stream is provided by at least one of a Computed-Tomography (CT) scanner, a Fluoroscopy apparatus, a Positron Emission Tomography (PET) scanner, an ultrasound apparatus and a molecular-based imaging system.

12. The method as claimed in claim 1, further comprising providing said generated algebraic equation to at least one of a ray-tracing unit, a storing unit and an analyzing unit.

13. An apparatus for generating a m-degree algebraic equation representative of an object, in a n-dimension space, said apparatus comprising:
an image acquisition data providing unit providing an image data stream representative of said object;
a data analyzing unit receiving said provided image data stream and providing an analyzed image data stream signal;
a processing unit receiving said analyzed image data stream signal, associating a plurality of control points on the analyzed image data stream signal according to a desired m-degree form to generate an algebraic equation signal; and
an algebraic equation providing unit receiving and providing said algebraic equation signal.

14. The apparatus as claimed in claim 13, further comprising a user interface receiving said algebraic equation signal and displaying a representation of said algebraic equation signal to a user.

15. The apparatus as claimed in claim 14, wherein said user interface further provides a configuration signal to said processing unit.

16. The apparatus as claimed in claim 14, wherein said user interface is adapted to further provide a manual input/feedback signal to said data analyzing unit.

17. The apparatus as claimed in claim 13, further comprising a segmented data storing unit receiving and storing at least one part of the analyzed image data stream signal.

18. The apparatus as claimed in claim 13, further comprising a control point storing unit receiving and storing at least one part of the associated plurality of control points.

19. An acquisition module for generating a m-degree form in a n-dimension space representative of an object, said acquisition module comprising:
a memory comprising an indication of at least one acquisition to perform, said indication being related to a geometric condition required for generating said m-degree form representative of said object;
a processing unit receiving said indication of said acquisition to perform and providing a request for performing an acquisition; and
a data acquisition unit for performing said acquisition of said object and providing an acquired signal in response to said request for performing said acquisition.

20. The acquisition module as claimed in claim 13, further comprising a data providing unit receiving said acquired signal.

21. A method for acquiring data used- to generate a m-degree form, representative of an object, in a n-dimension space, said method comprising:
selecting an indication of at least one acquisition to perform in a database comprising said indication of at least one acquisition to perform, said indication being related to a geometric condition required for generating said m-degree form representative of said objects;
performing said acquisition using said selected indication of at least one acquisition to perform to provide an acquired signal; and
processing said acquired signal to provide a processed acquired signal.
